(19) United States
(12) Patent Application Publication
(10) Pub. No.: US 2024/0387080 A1
(43) Pub. Date: Nov. 21, 2024

(54) OVER-CURRENT PROTECTION DEVICE

(71) Applicant: Polytronics Technology Corp., Hsinchu (TW)

(72) Inventors: Chen-Nan LIU, Pitou Township (TW); Hsiu-Che YEN, Taoyuan City (TW); Chia-Yuan LEE, Hsinchu City (TW); Chingting CHIU, Taoyuan City (TW); Cheng-Yu TUNG, Tainan City (TW); Yung-Hsien CHANG, Douliu City (TW); Yao-Te CHANG, Linnei Township (TW); Fu-Hua CHU, TAIPEI CITY (TW)

(21) Appl. No.: 18/390,541

(22) Filed: Dec. 20, 2023

(30) Foreign Application Priority Data
May 16, 2023 (TW) 112118002

(51) Int. Cl. H01C 7/02; H01C 1/14

(52) U.S. Cl. CPC H01C 7/021; H01C 1/1406; H01C 7/023

(57) ABSTRACT

An over-current protection device includes an electrode layer and a heat-sensitive layer. The heat-sensitive layer exhibits a positive temperature coefficient (PTC) characteristic, and is laminated between a top metal layer and a bottom metal layer of the electrode layer. The heat-sensitive layer includes a polymer matrix and a conductive filler. The polymer matrix includes a fluorine-containing copolymer, and its melting point ranges from 210° C. to 240° C. The conductive filler consists of carbon black solely, and is used to form an electrically conductive path in the heat-sensitive layer. In addition, the over-current protection device has a resistance-jump ratio ranging from 1.2 to 1.3 between 40° C. and 130° C.

### BACKGROUND OF THE INVENTION

### (1) Field of the Invention

The present application relates to an over-current protection device, and more specifically, to an over-current protection device with excellent electrical resistance stability and high activating temperature.

### (2) Description of the Related Art

Because the electrical resistance of conductive composite materials having a positive temperature coefficient (PTC) characteristic is very sensitive to temperature variation, they can be used as the materials for current sensing devices and have been widely applied to over-current protection devices or circuit devices. More specifically, the electrical resistance of the PTC conductive composite material remains extremely low at normal temperatures, so that the circuit or battery cell can operate normally. However, when an over-current or an over-temperature situation occurs in the circuit or cell, the electrical resistance will instantaneously increase to a high electrical resistance state (e.g., at least above 10⁴ Ω), which is the so-called “trip”. Therefore, the over-current will be eliminated so as to protect the cell or the circuit device.

The basic structure of the over-current protection device consists of a PTC material layer with two electrodes bonded to two opposite sides of the PTC material layer. The PTC material layer includes a matrix and a conductive filler. The matrix generally consists of one or more polymers, and the conductive filler is uniformly dispersed in the matrix and is used as an electrically conductive path. Conventionally, in order to provide high-temperature overheating protection for electronic apparatuses, the polymer matrix often includes polyvinylidene difluoride with high melting point (compared to commonly used polyethylene) as its major constituent. To enhance voltage endurance capability, the conductive filler consists of carbon black, rather than a combination of carbon black and metallic material(s). Combining polyvinylidene difluoride and pure carbon black allows the manufacture of an over-current protection device with high-temperature overheating protection and high-voltage endurance capability. However, such type of over-current protection device has at least two issues: firstly, the over-current protection device has poor electrical resistance stability in the low-temperature range before the trip event occurs; and secondly, the high-temperature operability of polyvinylidene difluoride cannot meet the requirement of the automotive industry for high-temperature overheating protection. Regarding the first issue, in the low-temperature range of approximately 40° C. to 130° C., there is a significant increase in the electrical resistance of the over-current protection device as the temperature rises. Such temperature sensitivity of the over-current protection device leads to a reduction in the current flow through the electronic apparatus under the operable temperature. Regarding the second issue, the activating temperature of polyvinylidene difluoride is around 160° C., which is too low for the automotive industry's high-temperature requirement. The activating temperature may be referred to as “starting jump temperature of resistance,” and it is a temperature point where the electrical resistance starts to significantly increase. It is understood that the electronic module in a car includes several electronic components, and the normal operating temperature of these electronic components can reach up to 150° C. to 160° C. If the activating temperature of the over-current protection device is lower than or around 160° C., the current in the over-current protection device decreases or is completely cut off in the car before reaching this temperature, potentially causing the electronic components to shut down at their normal operating temperature. In addition, as the automotive industry develops, the normal operating temperature of automotive electronic components in the future may continue to increase (i.e., exceeding 160° C.). Therefore, the activating temperature of the over-current protection device must be significantly higher than 160° C.

Accordingly, there is a need to improve the electrical resistance stability and high-temperature operability of the over-current protection device.

### SUMMARY OF THE INVENTION

The present invention provides an over-current protection device with high-voltage endurance capability and high activating temperature, which is suitable to be used as a protection device in the automotive industry. The over-current protection device has a heat-sensitive layer exhibiting a positive temperature coefficient (PTC) characteristic, and the heat-sensitive layer has a polymer matrix and a conductive filler consisting of carbon black solely. It is noted that the polymer matrix of the present invention includes a fluorine-containing copolymer as its major constituent. The fluorine-containing copolymer can address the issue of the electrical resistance stability of the conductive filler as described above, allowing the over-current protection device to maintain its low electrical resistance state in the low-temperature range before the trip event occurs. Furthermore, with the appropriate ratio, the fluorine-containing copolymer can adjust the over-current protection device's starting jump temperature of resistance to be between 200° C. and 210° C. According to the above improvement, the over-current protection device can meet the requirement of the automotive industry for high-temperature overheating protection.

In accordance with an aspect of the present invention, an over-current protection device includes an electrode layer and a heat-sensitive layer. The electrode layer has a top metal layer and a bottom metal layer. The heat-sensitive layer contacts the top metal layer and the bottom metal layer, and is laminated therebetween. The heat-sensitive layer exhibits a positive temperature coefficient (PTC) characteristic, and includes a polymer matrix and a conductive filler. The polymer matrix includes a fluorine-containing copolymer. The fluorine-containing copolymer is a copolymer polymerized from a fluorine-free olefin monomer and a fluorine-containing olefin monomer, and has a melting point ranging from 215° C. to 240° C. The conductive filler consists of carbon black solely and is dispersed in the polymer matrix, thereby forming an electrically conductive path in the heat-sensitive layer. In addition, the over-current protection device has a resistance-jump ratio ranging from 1.2 to 1.3 between 40° C. and 130° C.

In an embodiment, the over-current protection device has an electrical resistance ranging from 0.02 Ω to 0.03 Ω at 130° C.

In an embodiment, the over-current protection device has a starting temperature of resistance jump ranging from 200° C. to 210° C.

In an embodiment, the over-current protection device has a peak resistance higher than 4×10⁴ Ω after tripping.

In an embodiment, the total volume of the heat-sensitive layer is calculated as 100%, and the fluorine-containing copolymer accounts for 48% to 60%.

In an embodiment, the fluorine-containing copolymer is ethylene-tetrafluoroethylene copolymer.

In an embodiment, the total volume of the heat-sensitive layer is calculated as 100%, and the conductive filler accounts for 27% to 34%.

In an embodiment, the polymer matrix further comprises a nucleating material. The nucleating material is selected from the group consisting of polytetrafluoroethylene, tetrafluoroethylene-hexafluoro-propylene copolymer, perfluoroalkoxy modified tetrafluoroethylenes, vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and mixture or copolymer of combinations thereof. The total volume of the heat-sensitive layer is calculated as 100%, and the nucleating material accounts for 4% to 6%.

In an embodiment, the polymer matrix does not include poly(chlorotri-fluorotetrafluoroethylene).

In an embodiment, a melting point of the fluorine-containing copolymer is lower than a melting point of the nucleating material, and a difference between the melting point of the fluorine-containing copolymer and the melting point of the nucleating material ranges from 110° C. to 140° C.

In an embodiment, the nucleating material is polytetrafluoroethylene.

In an embodiment, the heat-sensitive layer has a thickness ranging from 0.12 mm to 0.15 mm.

In an embodiment, the over-current protection device has a first thermal derating ratio of trip current ranging from 65% to 79%. The first thermal derating ratio of trip current is calculated by dividing a required trip current of the over-current protection device under 85° C. by a required trip current of the over-current protection device under 25° C., and is represented by percentage.

In an embodiment, the over-current protection device has a second thermal derating ratio of trip current ranging from 53% to 60%. The second thermal derating ratio of trip current is calculated by dividing a required trip current of the over-current protection device under 125° C. by a required trip current of the over-current protection device under 25° C., and is represented by percentage.

In an embodiment, the over-current protection device has a third thermal derating ratio of trip current ranging from 69% to 82%. The third thermal derating ratio of trip current is calculated by dividing a required trip current of the over-current protection device under 125° C. by a required trip current of the over-current protection device under 85° C., and is represented by percentage.

In an embodiment, the heat-sensitive layer further includes a flame retardant. The flame retardant is selected from the group consisting of zinc oxide, antimony oxide, aluminum oxide, silicon oxide, calcium carbonate, magnesium sulfate, barium sulfate, magnesium hydroxide, aluminum hydroxide, calcium hydroxide, barium hydroxide, and any combination thereof. The total volume of the heat-sensitive layer is calculated as 100%, and the flame retardant accounts for 9% to 13%.

In an embodiment, the flame retardant is magnesium hydroxide.

In an embodiment, the over-current protection device has an endurable voltage of 24V, thereby allowing the over-current protection device to pass a cycle life test set at the endurable voltage without burnout. The cycle life test involves applying a power of 24 V/40A for 500 cycles.

In an embodiment, the over-current protection device has an endurable power per unit area ranging from 1.9 W/mm² to 2.7 W/mm² at 25° C.

In an embodiment, the over-current protection device has an endurable power per unit area ranging from 1 W/mm² to 1.5 W/mm² at 125° C.

### BRIEF DESCRIPTION OF THE DRAWINGS

The present application will be described according to the appended drawings in which:

FIG. 1 shows a cross-sectional view of an over-current protection device in accordance with an embodiment of the present invention;

FIG. 2 shows the top view of the over-current protection device shown in FIG. 1; and

FIGS. 3, 4 and 5 show the resulting curves from the resistance-temperature test (R-T test) for the over-current protection device.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

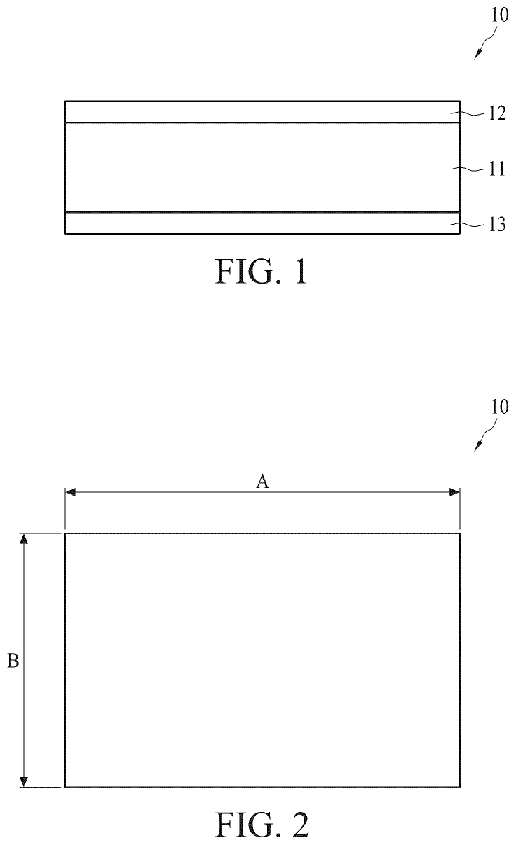

Please refer to FIG. 1. FIG. 1 shows one basic aspect of an over-current protection device 10 of the present invention in cross-sectional view. The over-current protection device 10 includes a heat-sensitive layer 11 and an electrode layer. The heat-sensitive layer 11 has a top surface and a bottom surface, and the electrode layer has a top metal layer 12 and a bottom metal layer 13 attached to the top surface and the bottom surface, respectively. Therefore, the heat-sensitive layer 11 physically contacts the top metal layer 12 and the bottom metal layer 13, and is laminated therebetween. In an embodiment, the top metal layer 12 and the bottom metal layer 13 may be composed of the nickel-plated copper foils or other conductive metals. In addition, the heat-sensitive layer 11 includes a polymer matrix and a conductive filler. The polymer matrix is an electrical insulator sensitive to heat, and the conductive filler is a conductor, by which the heat-sensitive layer 11 exhibits PTC characteristic. The over-current protection device 10 does not operate under normal condition, and therefore the conductive filler is uniformly dispersed in the polymer matrix, and particles of the conductive filler connect to each other in series, thereby forming an electrically conductive path; however, the polymer matrix rapidly expands when the over-current protection device 10 is subject to high temperature, and the particles of the conductive filler are pulled away from each other, thereby cutting off the electrically conductive path in the heat-sensitive layer 11. In other words, the PTC characteristic is substantially determined by the type of the polymer matrix and its proportion relative to the conductive filler. Accordingly, the polymer matrix of the present invention includes a fluorine-containing copolymer. The fluorine-containing copolymer is added in proper proportion, which enhances the electrical resistance stability and increases the activating temperature of the over-current protection device 10.

According to the present invention, the fluorine-containing copolymer is a copolymer polymerized from a fluorine-free olefin monomer and a fluorine-containing olefin monomer, and has a melting point ranging from 215° C. to 240° C. For example, the fluorine-free olefin monomer may be ethylene, propylene, butene, pentene, or hexene, while the fluorine-containing olefin monomer may be tetrafluoroethylene. Because of the high stability of the fluorine-containing copolymer under high temperature, the over-current protection device 10 can maintain its low electrical resistance state in the low-temperature range (40° C. to 130° C.). More specifically, the over-current protection device 10 has a first electrical resistance at 40° C., and has a second electrical resistance at 130° C. A ratio by dividing the second electrical resistance by the first electrical resistance ranges from 1.2 to 1.3. The ratio can be referred to as the resistance-jump ratio, which indicates the influence of high temperature on the change of electrical resistance. The resistance-jump ratio of the over-current protection device 10 of the present invention ranges from 1.2 to 1.3, which is very close to 1. This means that the resistance value does not change significantly in the low-temperature range (40° C. to 130° C.) before the trip event occurs, allowing the over-current protection device 10 to have a steady current flow without affecting the normal operation of electronic components. In an embodiment, both the first electrical resistance and the second electrical resistance fall within the range of 0.02 Ω to 0.03 Ω. Furthermore, the heat-sensitive layer with carbon black as the sole conductive filler exhibits higher voltage endurance capability than the one with the combination of carbon black and metallic material(s) as its conductive filler. If the same endurable voltage is intended to be achieved for the over-current protection devices of the present invention and the conventional one, the heat-sensitive layer 11 of the present invention can be made to have a thickness thinner than the conventional one. In an embodiment, the thickness of the heat-sensitive layer 11 ranges from 0.12 mm to 0.15 mm. In another embodiment, the thickness of the heat-sensitive layer 11 may be 0.12 mm, 0.13 mm, 0.14 mm, or 0.15 mm. Due to the presence of the fluorine-containing copolymer, the present invention significantly improves the electrical resistance stability in the low-temperature range and allows the over-current protection device 10 to leverage the advantage of carbon black conductive filler (i.e., enhancing voltage endurance capability) while adjusting the thickness of the heat-sensitive layer 11 to be thinner.

In the present invention, the selection of the fluorine-containing copolymer as the major constituent of the polymer matrix also considers the automotive industry's need for high-temperature overheating protection. The fluorine-containing copolymer allows the starting jump temperature of resistance of the over-current protection device 10 to be in the range of 200° C. to 210° C., such as 200° C., 201° C., 202° C., 203° C., 204° C., 205° C., 206° C., 207° C., 208° C., 209° C., or 210° C. In the present invention, the starting jump temperature of resistance may preferably range from 203° C. to 208° C. As long as the composition of the present invention is followed (details will be further provided below), the starting jump temperature of resistance would generally fall within the range of 203° C. to 208° C. The starting jump temperature of resistance is the initiation temperature where the electrical resistance starts to significantly increase. That is, the starting jump temperature is not the temperature where the electrical resistance of the over-current protection device 10 has reached its maximum, but is the starting point of temperature where the electrical resistance of the over-current protection device 10 begins to increase abruptly. As the temperature increases to around 220° C. to 230° C., the over-current protection device 10 reaches to the high electrical resistance state (i.e., the state that the electrical resistance is above 10⁴ Ω).

It is noted that during operation, the internal core temperature of a car may reach up to 180° C., and generally, the electronic components can function normally within the range of 150° C. to 160° C. As the automotive industry develops, the normal operating temperature of automotive electronic components increases than before, e.g., exceeding 160° C. and even up to 180° C. in the near future. Therefore, the starting jump temperature of resistance of the over-current protection device 10 needs to be higher than the conventional one but controlled below the limit. For example, if the starting jump temperature of resistance is lower than 200° C., this initiation temperature for significantly increase in resistance is too close to the normal operating temperature of the electronic components in the car. This proximity may increase the possibility to cut off the current prematurely (i.e., before the expected timing) by the over-current protection device 10. On the other hand, it is noted that before the temperature reaches the starting jump temperature of resistance, the electrical resistance of the over-current protection device 10 has gradually increased. Even if the current is not completely cut off, the normal function of the electronic components in the car is still compromised when the starting jump temperature of resistance approaches the temperature range of 150° C. to 180° C. Apparently, the low starting jump temperature of resistance causes an adverse impact on the normal operation of automotive electronic components.

On the other hand, if the starting jump temperature of resistance is higher than 210° C., it can lead to the issue of solder melting. More specifically, the over-current protection device 10 is typically assembled on the circuit board (or other supportive substrates) by solder, which generally has a melting point lower than 260° C., with solder softening and phase transition occurring at around 230° C. If the starting jump temperature of resistance of the over-current protection device 10 is too close to 230° C., the timing of cutting off the current is too late to prevent the excessive increase in temperature. The increased temperature may be sufficient to soften or even melt the solder, which makes the over-current protection device 10 detached from the circuit board (or other supportive substrates).

It is noted that the starting jump temperature of resistance in the present invention is at least 200° C., which means that the major constituent of the polymer matrix must also have a melting point higher than this temperature. In the present invention, the polymer matrix does not include polyvinylidene difluoride, which has a low melting point of around 177° C., but instead includes the fluorine-containing copolymer. The fluorine-containing copolymer may preferably be ethylene-tetrafluoroethylene copolymer. It is understood that ethylene-tetrafluoroethylene copolymer may have different melting points depending on the polymerization method, and the melting point may be relatively high (above 280° C.) or low (below 240° C.). The present invention includes the relatively low one of ethylene-tetrafluoroethylene copolymer. Besides the starting jump temperature of resistance as described above, the issue of processability is also taken into consideration. Ethylene-tetrafluoroethylene copolymer having low melting point facilitates the blending processability when the polymer matrix is mixed with the conductive filler. If the melting point of ethylene- tetrafluoroethylene copolymer is higher than 240° C., the blending mixture between the polymer matrix and the conductive filler is too stable under high temperature. Because the stability is unfavorably high, the blending mixture is difficult to be processed during the following hot pressing step. In an embodiment, the melting point of ethylene-tetrafluoroethylene copolymer preferably ranges from 220° C. to 230° C. In this way, the over-current protection device 10 has better thermal stability without affecting the blending process.

The heat-sensitive layer 11 of the present invention may further include a nucleating material. The nucleating material is selected from the group consisting of polytetrafluoroethylene, tetrafluoroethylene-hexafluoro-propylene copolymer, perfluoroalkoxy modified tetrafluoroethylenes, vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and mixture or copolymer of combinations thereof. The melting point of the fluorine-containing copolymer is lower than that of the nucleating material. The difference between the melting point of the fluorine-containing copolymer and the melting point of the nucleating material ranges from 110° C. to 140° C., such as 110° C., 115° C., 120° C., 125° C., 130° C., 135° C., or 140° C. When the environmental temperature is higher than the melting point of the fluorine-containing copolymer but lower than the melting point of the nucleating material, the fluorine-containing copolymer melts while the nucleating material does not. In this way, particles of the nucleating material remain in the solid state, and are uniformly dispersed in the heat-sensitive layer 11, thereby functioning as nucleation sites for recrystallization of the fluorine-containing copolymer. The nucleation sites are favorable to recrystallization of the fluorine-containing copolymer. Moreover, deformation of the nucleating material is less severe under high temperature condition because of its high melting temperature, by which the structure of the heat-sensitive layer 11 is stabilized by the nucleating material and does not deform severely. In an embodiment, ethylene-tetrafluoroethylene copolymer is the major constituent (i.e., the aforementioned fluorine-containing copolymer), while polytetrafluoroethylene is the minor constituent (i.e., the aforementioned nucleating material) in the polymer matrix; and the total volume of the heat-sensitive layer is calculated as 100%, and ethylene-tetrafluoroethylene copolymer accounts for 48% to 60% and polytetrafluoroethylene accounts for 4% to 6%. In an embodiment, the total volume of the heat-sensitive layer 11 is calculated as 100%, and ethylene-tetrafluoroethylene copolymer accounts for 48%, 49%, 50%, 51%, 52%, 53%, 54%, 55%, 56%, 57%, 58%, 59%, or 60%. In an embodiment, the total volume of the heat-sensitive layer 11 is calculated as 100%, and polytetrafluoroethylene accounts for 4%, 4.5%, 5%, 5.5%, or 6%. In a preferred embodiment, the total volume of the heat-sensitive layer 11 is calculated as 100%, and ethylene-tetrafluoroethylene copolymer accounts for 48% to 57% and polytetrafluoroethylene accounts for 5%. Considering the requirement of the automotive industry, the amount of polytetrafluoroethylene is set within the aforementioned range. Its amount would not be high enough to affect the starting jump temperature of resistance of the over-current protection device 10, while also allowing for fine-tuning of the overall thermal stability of the polymer matrix. In addition, because of the processability, the present invention does not include poly(chlorotri-fluorotetrafluoroethylene) as the nucleating material. Poly(chlorotri-fluorotetrafluoroethylene) and other materials (e.g., ethylene-tetrafluoroethylene copolymer and other fillers) form a mixture when extruded, and this mixture tends to break, crack, or produce smoke, making it unsuitable for the present invention.

As for the conductive filler, it does not include any metal material. The metal material may be tungsten carbide, titanium carbide, vanadium carbide, zirconium carbide, niobium carbide, tantalum carbide, molybdenum carbide, hafnium carbide, titanium boride, vanadium boride, zirconium boride, niobium boride, molybdenum boride, hafnium boride, or zirconium nitride. As described above, the conductive filler of the present invention consists of carbon black solely, and consequently the present invention allows the heat-sensitive layer 11 to be made thinner while still achieving high-voltage endurance capability. In an embodiment, the total volume of the heat-sensitive layer 11 is calculated as 100%, and the conductive filler (i.e., carbon black) accounts for 27% to 34%.

Moreover, the over-current protection device 10 of the present invention may include other excellent electrical characteristics. This will be explained and demonstrated through the thermal derating effect test for trip current and the cycle life test with different specified powers.

Regarding the thermal derating effect test, the over-current protection device 10 is placed under several different environmental temperatures, and the required trip current can be measured at each environmental temperature. In the relatively low temperature environment, the over-current protection device 10 has a lower electrical resistance, leading to a relatively higher required trip current. In the relatively high temperature environment, the over-current protection device 10 has a higher electrical resistance, leading to a relatively lower required trip current. In other words, an increase in temperature causes the required trip current to decrease, and this phenomenon can be referred to as thermal derating effect. The thermal derating effect test is used to compare different required trip currents under different environmental temperatures, particularly observing the effect of high temperature on device operation of the present invention. Ideally, the user would expect the same (or similar) value of the required trip currents of the over-current protection device 10 under different environmental temperatures so that the over-current protection device 10 can perform its function of over-current protection at a stable preset current (i.e., the preset required trip current), which is beneficial to operational convenience. The over-current protection device 10 of the present invention demonstrates different thermal derating ratios of trip current in three different temperature ranges (referred to as first temperature range, second temperature range, and third temperature range hereinafter). In the first temperature range (25° C. to 85° C.), the over-current protection device 10 has a first thermal derating ratio of trip current ranging from 65% to 79%. The first thermal derating ratio of trip current is defined as a value by dividing a required trip current of the over-current protection device under 85° C. by a required trip current of the over-current protection device under 25° C., and this value is represented by percentage. In the second temperature range (25° C. to 125° C.), the over-current protection device 10 has a second thermal derating ratio of trip current ranging from 53% to 60%. The second thermal derating ratio of trip current is defined as a value by dividing a required trip current of the over-current protection device under 125° C. by a required trip current of the over-current protection device under 25° C., and this value is represented by percentage. In the third temperature range (85° C. to 125° C.), the over-current protection device 10 has a third thermal derating ratio of trip current ranging from 69% to 82%. The third thermal derating ratio of trip current is defined as a value by dividing a required trip current of the over-current protection device under 125° C. by a required trip current of the over-current protection device under 85° C., and this value is represented by percentage. It is understood that in the conventional over-current protection device, thermal derating ratios of trip current generally fall within the range of 30% to 60% in either temperature range described above. However, in the over-current protection device 10 of the present invention, thermal derating ratios of trip current can reach up to 80% or more, indicating that its required trip currents are less affected by temperature. The over-current protection device 10 can perform its function of over-current protection at a stable preset current, which is beneficial to operational convenience.

Regarding the cycle life test, the heat-sensitive layer 11 of the over-current protection device 10 can still withstand a high voltage of 24V when it has a small thickness ranging from 0.12 mm to 0.15 mm. More specifically, in a preferred embodiment, the heat-sensitive layer 11 further includes a specific proportion of flame retardant. The flame retardant is selected from the group consisting of zinc oxide, antimony oxide, aluminum oxide, silicon oxide, calcium carbonate, magnesium sulfate, barium sulfate, magnesium hydroxide, aluminum hydroxide, calcium hydroxide, barium hydroxide, and any combination thereof. The total volume of the heat-sensitive layer is calculated as 100%, and the flame retardant accounts for far higher than 5% (e.g., 9% to 13%). By reducing the flammability with the flame retardant, the over-current protection device 10 can pass high-voltage or high-power (e.g., 24V/40 A) cycle life tests without burnout. Moreover, the over-current protection device 10 has an endurable power per unit area ranging from 1 W/mm² to 1.5 W/mm² at 125° C., and its maximum is significantly higher than that of the conventional over-current protection device, which has an endurable power per unit area less than 1 W/mm² at 125° C.

Please refer to FIG. 2, which shows the top view of the over-current protection device 10 in FIG. 1. The over-current protection device 10 has a length A and a width B, and the top-view area “A×B” of the over-current protection device 10 is substantially equivalent to the top-view area of the heat-sensitive layer 11. The heat-sensitive layer 11 may have a top-view area ranging from 4 mm² to 72 mm² based on different products having different sizes. For example, the top-view area “A×B” may be 2×2 mm², 5×5 mm², 5.1×6.1 mm², 5×7 mm², 7.62×7.62 mm², 7.8×8.15 mm², 7.3×9.5 mm², 7.62×9.35 mm². In addition, the total thickness of the over-current protection device 10 (i.e., the total thickness of the top metal layer 12, the heat-sensitive layer 11, and the bottom metal layer 13) ranges from 0.19 mm to 0.22 mm. In an embodiment, the top-view area of the over-current protection device 10 is 63.57 mm² (i.e., 7.8×8.15 mm²), and the thickness of it is 0.22 mm. In another embodiment, the top-view area of the over-current protection device 10 is 58.06 mm² (i.e., 7.62×7.62 mm²), and the thickness of it is 0.19 mm. It is understood that the present invention can apply to any size of the over-current protection device 10 described above to achieve the same technical effect.

As described above, the present invention allows the over-current protection device 10 to exhibit excellent electrical characteristics under high temperature. It can be verified according to the experimental data in Table 1 to Table 6 as shown below.

TABLE 1
Volume percentage (vol %) of the heat-sensitive layer.

| Group | ETFE | PVDF | PTFE | Mg(OH)₂ | CB |
|---|---|---|---|---|---|
| E1 | 58.0 | | 5.0 | 5.0 | 32.0 |
| E2 | 60.0 | | 5.0 | 3.0 | 32.0 |
| E3 | 57.0 | | 5.0 | 11.0 | 27.0 |
| E4 | 57.0 | | 5.0 | 9.0 | 29.0 |
| E5 | 48.0 | | 5.0 | 13.0 | 34.0 |
| C1 | | 58.0 | 5.0 | 3.0 | 34.0 |

Table 1 shows the volume percentage composition of the heat-sensitive layer in accordance with the embodiments (E1-E5) of the present disclosure and the comparative example (C1). The first column in Table 1 shows test groups E1-C1 from top to bottom. The first row in Table 1 shows various materials used for the heat-sensitive layer from left to right, that is, ethylene-tetrafluoroethylene copolymer (ETFE), polyvinylidene difluoride (PVDF), polytetrafluoroethylene (PTFE), magnesium hydroxide (Mg(OH)₂), and carbon black (CB). Each group uses magnesium hydroxide as the flame retardant. As for the conductive filler, it consists of carbon black solely in order to enhance the endurance capability.

In the embodiments E1 to E4 of the present invention, the major constituent of the polymer matrix is ETFE, and the minor constituent of the polymer matrix is PTFE. Since PTFE has a much higher melting point (about 330° C.) than that of ETFE, the proportion of PTFE must not be too high to avoid affecting the protection temperature and other unexpectedly adverse issues to the trip event of the over-current protection device. Considering that PTFE acts as the nucleating material, the difference between melting points of ETFE and PTFE should be at least 110° C., preferably 110° C. to 140° C. If the melting point difference is too small, both polymers would soften or melt simultaneously under the same high temperature; in this situation, the nucleating material would lose its role as a nucleating center and structural stabilizer. If the melting point difference is too large, it becomes challenging to control the proportion of the nucleating material, as even a slight change in its proportion can significantly affect the thermal stability of the heat-sensitive layer. That is, if the melting point difference exceeds 140° C., the thermal stability of the heat-sensitive layer would be overly sensitive to the amount of the nucleating material, resulting in a very limited margin for error tolerance during formulation. In addition, the proportion of the polymer matrix (i.e., ETFE and PTFE) in the heat-sensitive layer needs to be controlled within an ideal range. An excessively low proportion of the polymer matrix results in an inability to completely cut off the current during the trip event, while an excessively high proportion of the polymer matrix leads to poor electrical conductivity. According to the composition of the present invention, the polymer matrix accounts for 53% to 65% by volume in the heat-sensitive layer. Considering the measurement error and according to the practical use, the polymer matrix may account for 51% to 67% while still achieving the same technical effect.

In the comparative example C1, the major constituent of the polymer matrix is PVDF, and the minor constituent of the polymer matrix is PTFE. Conventionally, in order to manufacture the over-current protection device for high-temperature overheating protection and with high thermal stability, the polymer matrix often includes polyvinylidene difluoride as its major constituent. However, the following tests will show that the embodiments E1 to E4 are advantageous over the comparative example C1 when it comes to application to high-temperature overheating protection.

The manufacturing process of the embodiments E1 to E5 and the comparative example C1 is described below. According to the composition shown in Table 1, materials are prepared and put into HAAKE twin screw blender for blending. The blending temperature for the embodiments is 240° C., and the blending temperature for the comparative example is 215° C. The time for pre-mixing is 3 minutes, and the blending time is 15 minutes. The conductive polymer after being blended is pressed into a sheet by a hot press machine at a high temperature (i.e., 250° C. for the embodiments and 210° C. for the comparative example) and a pressure of 150 kg/cm². The sheet is then cut into pieces of about 20 cm×20 cm, and two nickel-plated copper foils are laminated to two sides of the sheet with the hot press machine at the high temperature (i.e., 250° C. for the embodiments and 210° C. for the comparative example) and the pressure of 150 kg/cm², by which a three-layered structure is formed. Then, the sheet with the nickel-plated copper foils is punched into PTC chips, each of which is the over-current protection device. Each sample of the over-current protection device has the length of 7.8 mm and the width of 8.15 mm (i.e., top-view area is 63.57 mm²), and the thickness thereof is 0.22 mm. Then, the PTC chips of the embodiments and comparative example are subjected to electron beam irradiation of 50 kGy (irradiation dose can be adjusted depending on the requirement). After irradiation, the following measurements are performed by taking fifteen PTC chips as samples to be tested for each of the groups.

It is noted that the over-current protection device conventionally has poor electrical resistance stability in the low-temperature range, and its activating temperature does not meet the requirement of the automotive industry. Therefore, two resistance-temperature tests (referred to as “resistance-temperature test 1” and “resistance-temperature test 2” hereinafter) are conducted to illustrate the improvements in electrical resistance stability and activating temperature of the present invention compared to the conventional one.

Regarding the resistance-temperature test 1, the temperature condition is as follows: the temperature range to be tested is 40° C. to 130° C., the heating rate is 5° C./min, and each temperature point is held for 15 minutes. The holding time for each temperature point allows the over-current protection device to reflect the electrical resistance more accurately at a specific temperature. More particularly, at each temperature point in the environment, the 15-minute holding time allows the over-current protection device to fully absorb the heat, ensuring that its overall temperature indeed reaches each temperature point and matches the environmental temperature. This is beneficial for analyzing its resistance state before the trip event occurs.

TABLE 2
Resistance-temperature test 1.

| Group | R_{40° C.} (Ω) | R_{130° C.} (Ω) | R_{130° C.}/R_{40° C.} |
|---|---|---|---|
| E3 | 0.0218 | 0.0267 | 1.23 |
| C1 | 0.0167 | 0.0683 | 4.10 |

“R_{40° C.}” refers to the electrical resistance of the over-current protection device at 40° C.

“R_{130° C.}” refers to the electrical resistance of the over-current protection device at 130° C.

“R_{130° C.}/R_{40° C.}” is the ratio between R_{130° C.} and R_{40° C.}, that is, the resistance-jump ratio of high temperature to low temperature. The smaller the value is, the less fluctuation of the electrical resistance of the over-current protection device will be. A lower value of this ratio indicates that the electrical resistance is less affected by temperature and can maintain a stable low resistance state. In this way, the resistance-jump ratio can be used to assess the electrical conduction capability of the over-current protection device before the trip event occurs.

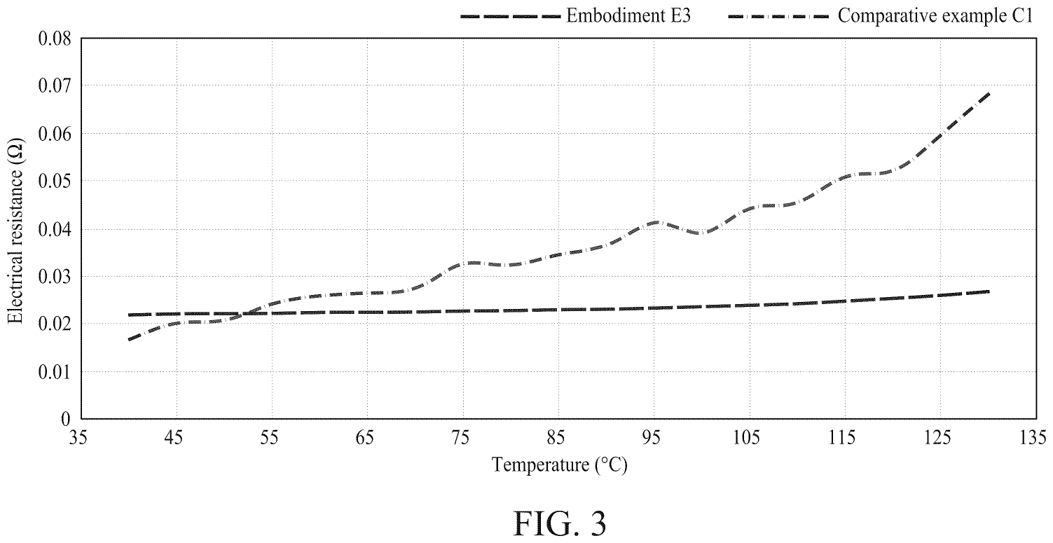

Please refer to Table 2 and FIG. 3. In FIG. 3, the Y-axis shows the electrical resistance, and the X-axis shows the temperature. From 40° C. to 130° C., the electrical resistance of the embodiment E3 increases slightly from 0.0218 Ω to 0.0267 Ω, and its resistance-jump ratio (R_{130° C.}/R_{40° C.}) is 1.23. The resistance-jump ratio (R_{130° C.}/R_{40° C.}) of the embodiment E3 is very close to 1, thereby obtaining a remarkably stable curve from 40° C. to 130° C. and maintaining the electrical resistance at approximately 0.02 Ω. In contrast, in the comparative example C1, its electrical resistance increases significantly from 0.0167 Ω to 0.0683 Ω within the temperature range of 40° C. to 130° C., and its resistance-jump ratio (R_{130° C.}/R_{40° C.}) is 4.10. The resistance-jump ratio (R_{130° C.}/R_{40° C.}) of the comparative example C1 is much higher than 1, resulting in a noticeable upward trend in its curve in FIG. 3. The results above show that during the un-tripped period, the over-current protection device 10 of the present invention can maintain a stable low-resistance state without affecting the normal operation of the protected electronic components.

Regarding the resistance-temperature test 2, the temperature condition is as follows: the temperature range to be tested is 40° C. to 230° C., starting from 40° C. and continuously increasing to 230° C. at a rate of 5° C./min. This test is used to observe the resistance jump (trip) of the over-current protection device.

TABLE 3
Resistance-temperature test 2.

| | Starting jump temperature of resistance | Peak resistance |
|---|---|---|
| Group | (° C.) | (Ω) |
| E1-E5 | 205 | 4.04 × 10⁴ |
| C1 | 165 | 2.04 × 10⁵ |

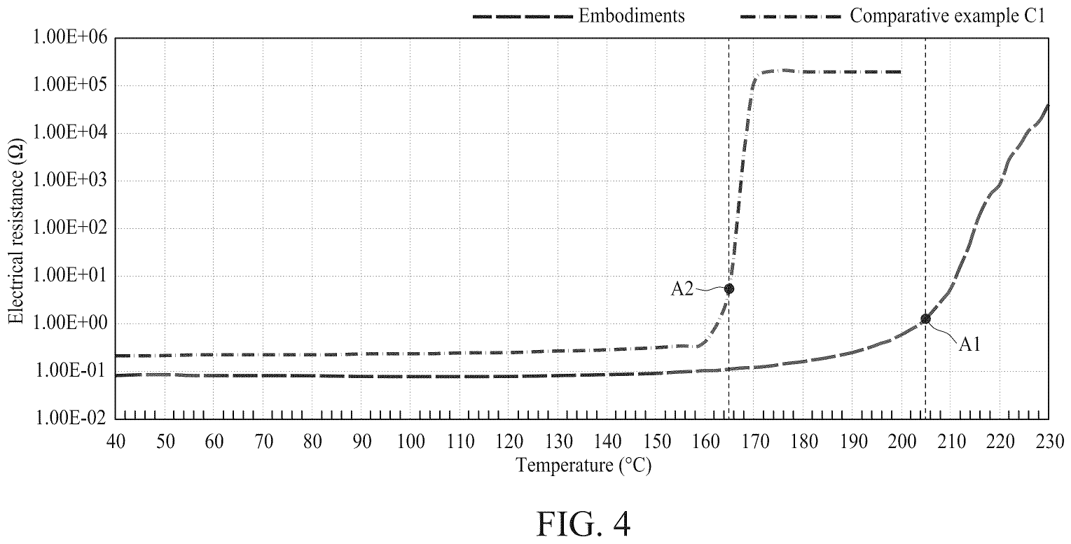

Please refer to Table 3 and FIG. 4. In FIG. 4, the Y-axis shows the electrical resistance, and the X-axis shows the temperature. It should be noted that the Y-axis in FIG. 4 is expressed in logarithmic scale, and as a result, the curves for the embodiments E1 to E5 almost overlap. Therefore, for ease of illustration in FIG. 4, the average of all the embodiments is presented as a single curve. The point A1 and point A2 are the starting points where the electrical resistance starts to significantly increase, and can be referred to as the starting points of resistance jump. The temperature point corresponding to the starting point of resistance jump is the starting jump temperature of resistance (C) in Table 3. The electrical resistance corresponding to the highest point of resistance jump is the peak resistance (Ω) in Table 3. In the embodiments E1 to E5, the starting jump temperature of resistance is 205° C., which meets the requirement of the automotive industry for high-temperature overheating protection. Considering the issue of solder melting, the starting jump temperature of resistance of the embodiments E1 to E5 is not so excessively high to cause a delayed trip event. It reaches a high electrical resistance state of 4.04×10⁴ Ω at 230° C. In contrast, the starting jump temperature of resistance of the comparative example C1 is 165° C., which means that the over-current protection device would trip at the normal operating temperature of automotive electronic components, potentially affecting their normal operation. Besides, if an unexpected event occurs that raises the temperature up to 200° C. in a short time (i.e., the time being too short to allow the device to provide the protection), the over-current protection device of the comparative example C1 is prone to crack due to its poor thermal stability.

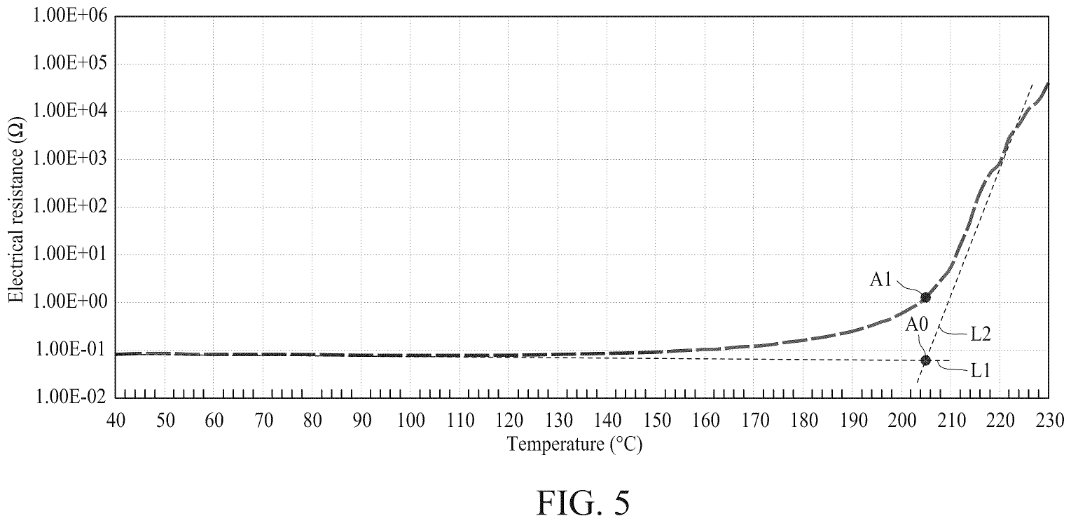

Please refer to FIG. 5, which further shows the definition of the starting jump temperature of resistance of the embodiments E1-E5 in the present invention. Before the trip event, the over-current protection device 10 is in the low electrical resistance state, and the curve changes in approximately linear extension over a temperature range. In this way, a tangent line L1 can be illustrated according to the approximately linear extension. During the trip event, the over-current protection device 10 is in the high electrical resistance state, and the curve abruptly changes in approximately linear extension over another temperature range. Likewise, a tangent line L2 can be illustrated according to the approximately linear extension. The equation of the tangent line L1 is y=0.000006x+0.0858. The equation of the tangent line L2 is y=60.145x−12713. From the above, the slope of the tangent line L1 is 0.000006 (referred to as “lowest slope” hereinafter), and the slope of the tangent line L2 is 60.145 (referred to as “highest slope” hereinafter). The tangent line L1 having the lowest slope intersects the tangent line L2 having the highest slope at the intersection point A0. The corresponding temperature on X-axis of the intersection point A0 is a switch point between the low electrical resistance state and the high electrical resistance state, that is, the starting jump temperature of resistance. The intersection point A0 overlaps the starting point of resistance jump A1 if it moves up along the direction parallel to Y-axis. Accordingly, the starting jump temperature of resistance can be precisely controlled in the range from 200° C. to 210° C. as long as the heat-sensitive layer 11 is formed of the composition according to the present invention.

Next, different cycle life tests are performed on the over-current protection device 10, and are used to assess the voltage endurance capability thereof. One cycle of the cycle life test includes applying a specified power for 10 seconds and turning it off for 60 seconds (i.e., on: 10 seconds; off: 60 seconds). In the following tests, there are two test conditions, and therefore two different cycle life tests (referred to as first cycle life test and second cycle life test hereinafter) are performed. The first cycle life test includes an applied power of 16V/50 A, and the cycle number thereof is 500. The second cycle life test includes an applied power of 24V/40 A, and the cycle number thereof is 500.

TABLE 4
Cycle life test.

| | Rᵢ | ρ | R_{16 V/50 A}_{_{—}}_{500 C} | | R_{24 V/40 A}_{_{—}}_{500 C} | |
|---|---|---|---|---|---|---|
| Group | (Ω) | (Ω · cm) | (Ω) | R_{16 V/50 A}_{_{—}}_{500 C}/Rᵢ | (Ω) | R_{24 V/40 A}_{_{—}}_{500 C}/Rᵢ |
| E1 | 0.01050 | 0.3035 | 0.0208 | 2.0 | — | — |
| E2 | 0.01417 | 0.4093 | 0.0361 | 2.5 | — | — |
| E3 | 0.02296 | 0.6634 | 0.0431 | 1.9 | 0.0268 | 1.2 |
| E4 | 0.01372 | 0.3964 | 0.0311 | 2.3 | 0.0368 | 2.7 |
| E5 | 0.01225 | 0.3539 | 0.0305 | 2.5 | 0.0333 | 2.7 |
| C1 | 0.01912 | 0.5525 | 0.0342 | 1.8 | 0.0344 | 1.8 |

In Table 4, the first row shows items to be tested from left to right.

“Rᵢ” refers to the initial electrical resistance of the over-current protection device at room temperature. Moreover, the electrical resistance formula is ρ=R×A/L. “R” is electrical resistance, “L” is length (thickness), and “A” is cross sectional area. Accordingly, the electrical resistivity of ρ can be calculated corresponding to Rᵢ.

“R_{16V/50A_500C}” refers to the electrical resistance of the over-current protection device after the first cycle life test, the electrical resistance of which is then measured when cooled back to room temperature. Therefore, a resistance-jump ratio (R_{16V/50A_500C}/Rᵢ) of the first cycle life test can be further calculated. The smaller the value (i.e., the more it's close to 1) is, the better the resistance recovery capability of the over-current protection device will be. The over-current protection device with small resistance-jump ratio has better capability for electrical resistance recovery from trip of device toward the low electrical resistance state. Likewise, “R_{24V/40A_500C}” refers to the electrical resistance of the over-current protection device after the second cycle life test, the electrical resistance of which is then measured when cooled back to room temperature. Therefore, a resistance-jump ratio (R_{24V/40A_500C}/Rᵢ) of the second cycle life test can be further calculated.

In the embodiments E1 to E5, all the initial electrical resistances (Rᵢ) generally fall within the range of 0.01 Ω to 0.014 Ω, all of which are lower than 0.019 Ω of the comparative example C1. More specifically, the initial electrical resistance (Rᵢ) of the embodiments E1, E2, E4, and E5 ranges from about 0.01 Ω·cm to about 0.014 Ω, and the corresponding electrical resistivity (ρ) ranges from about 0.30 Ω·cm to about 0.41 Ω·cm. It is noted that although the embodiment E3 has a slightly higher initial electrical resistance, its resistance-jump ratio (R_{16/50A_500C}/Rᵢ) in the first cycle life test is the lowest among all the embodiments E1 to E5, at 1.9. Moreover, the embodiment E3 can pass the second cycle life test without burnout, and its resistance-jump ratio (R_{24V/40A_500C}/Rᵢ) of the second cycle life test is much lower than that in the comparative example C1. In the embodiment E3, the resistance-jump ratio (R_{24V/40A_500C}/Rᵢ) of the second cycle life test is 1.2, which is quite close to 1, indicating that the electrical resistance undergoes little change when the device is cooled back to room temperature after the trip event. Obviously, the advantages of the embodiment E3 in electrical resistance stability can be demonstrated under higher voltage and higher power conditions. The embodiments E1 and E2 are burnt out during the second cycle life test, and therefore their data regarding R_{24V/40A_500C} and R_{24V/40A_500C}/Rᵢ are not shown in Table 4.

TABLE 5
Trip current and endurable power.

| | | | | | Endurable power | Endurable power |
|---|---|---|---|---|---|---|
| | I-T_{25° C.} | I-T_{85° C.} | I-T_{125° C.} | I-T_{25° C.}/area | at 25° C. | at 125° C. |
| Group | (A) | (A) | (A) | (A/mm²) | (W/mm²) | (W/mm²) |
| E1 | 7.8 | 5.7 | 4.4 | 0.123 | 1.96 | 1.11 |
| E2 | 6.3 | 4.8 | 3.7 | 0.100 | 1.59 | 0.92 |
| E3 | 5.2 | 3.4 | 2.8 | 0.082 | 1.96 | 1.04 |
| E4 | 6.5 | 4.8 | 3.9 | 0.103 | 2.47 | 1.47 |
| E5 | 7.1 | 5.5 | 3.8 | 0.111 | 2.67 | 1.45 |
| C1 | 7.1 | 4.5 | 2.5 | 0.111 | 2.67 | 0.94 |

TABLE 6
Thermal derating ratio of trip current.

| Group | I-T_{85° C.}/I-T_{25° C.} | I-T_{125° C.}/I-T_{25° C.} | I-T_{125° C.}/I-T_{85° C.} |
|---|---|---|---|
| E1 | 73.5% | 56.4% | 76.7% |
| E2 | 75.8% | 57.9% | 76.4% |
| E3 | 65.4% | 53.2% | 81.4% |
| E4 | 73.5% | 59.7% | 81.3% |
| E5 | 78.3% | 54.2% | 69.3% |
| C1 | 63.6% | 35.3% | 55.6% |

As shown in Table 5, the first row shows items to be tested from left to right.

I-T_{25° C.}, I-T_{85° C.}, and I-T_{125° C.} refer to trip currents of the over-current protection device under the environmental temperatures of 25° C., 85° C., and 125° C., respectively.

“I-T_{25° C.}/area” and “Endurable power at 25° C.” can be calculated based on I-T_{25° C.}. I-T_{25° C.}/area refers to trip current per unit area of the over-current protection device under the environmental temperature of 25° C. Endurable power at 25° C. refers to endurable power per unit area of the over-current protection device under the environmental temperature of 25° C. “Endurable power at 125° C.” can be calculated based on I-T_{125° C.}, and refers to endurable power per unit area of the over-current protection device under the environmental temperature of 125° C.

In the embodiments E1 to E5, the endurable power at 25° C. generally ranges from 1.9 W/mm² to 2.7 W/mm², the maximum of which (i.e., 2.67 W/mm²) is the same as the conventional one (i.e., endurable power at 25° C. of the comparative example C1). However, when the environmental temperature rises to 125° C., the over-current protection devices 10 in the embodiments E1 to E5 can generally endure an applied power ranging from 1 W/mm² to 1.5 W/mm², which is higher than how much the conventional over-current protection device can endure (i.e., 0.94 W/mm² of the comparative example C1). From the above, as the temperature increases, the advantage of the over-current protection device 10 of the present invention gradually emerges. That is, at 125° C., the over-current protection device 10 of the present invention can withstand higher applied power without burnout, demonstrating better thermal stability.

Furthermore, the data of I-T_{25° C.}, I-T_{85° C.}, and I-T_{125° C.} are further analyzed and shown in Table 6.

As described above, the current required to trip the over-current protection device varies as it is exposed to different environmental temperatures. In the relatively low temperature environment, the over-current protection device 10 has a lower electrical resistance, leading to a relatively higher required trip current. In the relatively high temperature environment, the over-current protection device 10 has a higher electrical resistance, leading to a relatively lower required trip current. Therefore, the thermal derating effect can be utilized to assess the influence of high temperature on device operation.

I-T_{85° C.}/I-T_{25° C.} is the first thermal derating ratio of trip current as previously defined; I-T_{125° C.}/I-T_{25° C.} is the second thermal derating ratio of trip current as previously defined; and I-T_{125° C.}/I-T_{85° C.} is the third thermal derating ratio of trip current as previously defined. For ease of discussion, the ratios of the above three are all converted to percentages and presented in Table 6. If the percentage is 100%, it means that the trip current remains unchanged when the temperature switches between high and low temperatures, and the over-current protection device has the most ideal operating stability. Thus, as the thermal derating ratio of trip current approaches 100%, the degree of thermal derating effect decreases, and the operating stability becomes more ideal. In the embodiments E1 to E5, the first thermal derating ratio of trip current (I-T_{85° C.}/I-T_{25° C.}), the second thermal derating ratio of trip current (I-T_{125° C.}/I-T_{25° C.}), and the third thermal derating ratio of trip current (I-T_{125° C.}/I-T_{85° C.}) range from 65.4% to 78.3%, 53.2% to 59.7%, and 69.3% to 81.4%, respectively. These values are significantly higher than those in the comparative example C1, which are 63.6%, 35.3%, and 55.6%, respectively. It is noted that the difference in the thermal derating ratios of trip current becomes even more significant in high-temperature conditions.

More specifically, in the temperature range from 25° C. to 125° C., the segment from 25° C. to 85° C. represents a relatively lower temperature, while the segment from 85° C. to 125° C. represents a relatively higher temperature. At the relatively lower temperature, the first thermal derating ratio of trip current (I-T_{85° C.}/I-T_{25° C.}) of the embodiments E1 to E5 ranges from 65.4% to 78.3%, while the first thermal derating ratio of trip current (I-T_{85° C.}/I-T_{25° C.}) of the comparative example C1 is 63.6%. In other words, the embodiments E1 to E5 can differ by up to 14.7% from the comparative example C1. At the relatively higher temperature, the third thermal derating ratio of trip current (I-T_{125° C.}/I-T_{85° C.}) of the embodiments E1 to E5 ranges from 69.3% to 81.4%, while the third thermal derating ratio of trip current (I-T_{125° C.}/I-T_{85° C.}) of the comparative example C1 is 55.6%. The embodiments E1 to E5 differ from the comparative example C1 by at least about 14% and up to 25.8%. That is, the difference in trip current stability between the embodiments E1 to E5 and the comparative example C1 becomes more noticeable at the relatively higher temperature. Obviously, the embodiments E1 to E5 have the ratios closer to 100% and are advantageous over the comparative example C1. Regarding the third thermal derating ratio of trip current, the comparative example C1 not only demonstrates a significant difference from the embodiments E1 to E5, but also shows a nearly 50% reduction in trip current, indicating a severe thermal derating effect.

The above-described embodiments of the present invention are intended to be illustrative only. Numerous alternative embodiments may be devised by persons skilled in the art without departing from the scope of the following claims.

What is claimed is:

1. An over-current protection device, comprising:
an electrode layer having a top metal layer and a bottom metal layer; and
a heat-sensitive layer contacting the top metal layer and the bottom metal layer, and being laminated therebetween, wherein the heat-sensitive layer exhibits a positive temperature coefficient (PTC) characteristic and comprises:
a polymer matrix comprising a fluorine-containing copolymer, wherein the fluorine-containing copolymer is a copolymer polymerized from a fluorine-free olefin monomer and a fluorine-containing olefin monomer, and has a melting point ranging from 215° C. to 240° C.; and
a conductive filler consisting of carbon black and dispersed in the polymer matrix, thereby forming an electrically conductive path in the heat-sensitive layer;
wherein, the over-current protection device has a resistance-jump ratio ranging from 1.2 to 1.3 between 40° C. and 130° C.

2. The over-current protection device of claim 1, wherein the over-current protection device has an electrical resistance ranging from 0.02 Ω to 0.03 Ω at 130° C.

3. The over-current protection device of claim 1, wherein the over-current protection device has a starting temperature of resistance jump ranging from 200° C. to 210° C.

4. The over-current protection device of claim 1, wherein the over-current protection device has a peak resistance higher than 4×10⁴ Ω after tripping.

5. The over-current protection device of claim 1, wherein the total volume of the heat-sensitive layer is calculated as 100%, and the fluorine-containing copolymer accounts for 48% to 60%.

6. The over-current protection device of claim 5, wherein the fluorine-containing copolymer is ethylene-tetrafluoroethylene copolymer.

7. The over-current protection device of claim 6, wherein the total volume of the heat-sensitive layer is calculated as 100%, and the conductive filler accounts for 27% to 34%.

8. The over-current protection device of claim 1, wherein the polymer matrix further comprises a nucleating material selected from the group consisting of polytetrafluoroethylene, tetrafluoroethylene-hexafluoro-propylene copolymer, perfluoroalkoxy modified tetrafluoroethylenes, vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and mixture or copolymer of combinations thereof, wherein the total volume of the heat-sensitive layer is calculated as 100%, and the nucleating material accounts for 4% to 6%.

9. The over-current protection device of claim 8, wherein the polymer matrix does not comprise poly(chlorotri-fluorotetrafluoroethylene).

10. The over-current protection device of claim 8, wherein a melting point of the fluorine-containing copolymer is lower than a melting point of the nucleating material, and a difference between the melting point of the fluorine-containing copolymer and the melting point of the nucleating material ranges from 110° C. to 140° C.

11. The over-current protection device of claim 10, wherein the nucleating material is polytetrafluoroethylene.

12. The over-current protection device of claim 1, wherein the heat-sensitive layer has a thickness ranging from 0.12 mm to 0.15 mm.

13. The over-current protection device of claim 1, wherein the over-current protection device has a first thermal derating ratio of trip current ranging from 65% to 79%, wherein the first thermal derating ratio of trip current is calculated by dividing a required trip current of the over-current protection device under 85° C. by a required trip current of the over-current protection device under 25° C., and is expressed in percentage.

14. The over-current protection device of claim 1, wherein the over-current protection device has a second thermal derating ratio of trip current ranging from 53% to 60%, wherein the second thermal derating ratio of trip current is calculated by dividing a required trip current of the over-current protection device under 125° C. by a required trip current of the over-current protection device under 25° C., and is represented by percentage.

15. The over-current protection device of claim 1, wherein the over-current protection device has a third thermal derating ratio of trip current ranging from 69% to 82%, wherein the third thermal derating ratio of trip current is calculated by dividing a required trip current of the over-current protection device under 125° C. by a required trip current of the over-current protection device under 85° C., and is represented by percentage.

16. The over-current protection device of claim 1, wherein the heat-sensitive layer further comprises a flame retardant selected from the group consisting of zinc oxide, antimony oxide, aluminum oxide, silicon oxide, calcium carbonate, magnesium sulfate, barium sulfate, magnesium hydroxide, aluminum hydroxide, calcium hydroxide, barium hydroxide, and any combination thereof, wherein the total volume of the heat-sensitive layer is calculated as 100%, and the flame retardant accounts for 9% to 13%.

17. The over-current protection device of claim 16, wherein the flame retardant is magnesium hydroxide.

18. The over-current protection device of claim 1, wherein the over-current protection device has an endurable voltage of 24V, thereby allowing the over-current protection device to pass a cycle life test set at the endurable voltage without burnout, wherein the cycle life test involves applying a power of 24V/40 A for 500 cycles.

19. The over-current protection device of claim 1, wherein the over-current protection device has an endurable power per unit area ranging from 1.9 W/mm² to 2.7 W/mm² at 25° C.

20. The over-current protection device of claim 1, wherein the over-current protection device has an endurable power per unit area ranging from 1 W/mm² to 1.5 W/mm² at 125° C.
